(19) United States
(12) Patent Application Publication
(10) Pub. No.: US 2015/0030974 A1
(43) Pub. Date: Jan. 29, 2015

(54) PHOTOCONDUCTOR

(71) Applicant: XEROX CORPORATION, Norwalk, CT (US)

(72) Inventors: Gregory M. McGuire, Oakville (CA); Jennifer A. Coggan, Kitchener (CA); Alan E.J. Toth, Burlington (CA); Nan-Xing Hu, Oakville (CA); Yu Liu, Mississauga (CA)

(73) Assignee: XEROX CORPORATION, Norwalk, CT (US)

(21) Appl. No.: 13/948,548

(22) Filed: Jul. 23, 2013

(51) Int. Cl. G03G 5/06; G03G 13/06; G03G 13/04; G03G 5/05

(52) U.S. Cl. CPC G03G 5/0614; G03G 5/0525; G03G 13/06; G03G 13/04
USPC 430/58.8; 430/125.3; 430/132

(57) ABSTRACT

Described herein is a photoreceptor having a substrate, a charge generating layer, a charge transport layer comprising N,N,N′N′-tetra(4-methylphenyl)-(1,1′-biphenyl)-4,4′-diamine having a purity of from about 95 percent to about 100 percent, and a protective overcoat layer. The N,N,N′N′-tetra(4-methylphenyl)-(1,1′-biphenyl)-4,4′-diamine has been treated by a purification process two or more times.

### BACKGROUND

1. Field of Use

This disclosure is generally directed to layered imaging members, photoreceptors, photoconductors, and the like.

2. Background

There is a need to improve the functional performance of xerographic photoreceptors. For example, it is desirable to increase photodischarge speed of a photoreceptor to increase overall speed of xerographic machines. It is also desirable to have reliable manufacturing of xerographic machines.

### SUMMARY

Disclosed herein is a photoreceptor that includes a substrate, a charge generating layer, a charge transport layer and a protective overcoat layer. The charge transport layer includes N,N,N′N′-tetra(4-methylphenyl)-(1,1′-biphenyl)-4,4′-diamine having a purity of from about 95 percent to about 100 percent. The N,N,N′N′-tetra(4-methylphenyl)-(1,1′-biphenyl)-4,4′-diamine has been treated by a purification process two or more times.

Disclosed herein is a process for forming a photoreceptor. The process includes providing a photoreceptor substrate; applying a charge generating layer; applying a charge transport layer and applying a protective overcoat layer over the substrate. The charge transport layer includes N,N,N′N′-tetra(4-methylphenyl)-(1,1′-biphenyl)-4,4′-diamine having a purity of from about 95 percent to about 100 percent. The N,N,N′N′-tetra(4-methylphenyl)-(1,1′-biphenyl)-4,4′-diamine has been treated by a purification process two or more times. The purification process includes providing a mixture of N,N,N′N′-tetra(4-methylphenyl)-(1,1′-biphenyl)-4,4′-diamine and an absorbent selected from the group consisting of alumina, silica, magnesium sulfate and activated clays. A solvent is refluxed through the mixture at a temperature of from about 80° C. to about 180° C. for a period of time of from about 4 hours to about 48 hours. The solvent to obtain the N,N,N′N′-tetra(4-methylphenyl)-(1,1′-biphenyl)-4,4′-diamine

Disclosed herein is a method of forming an image. The method includes applying a charge to a photoreceptor comprising at least a charge transport layer comprising N,N,N′N′-tetra(4-methylphenyl)-(1,1′-biphenyl)-4,4′-diamine having a purity of from about 95 percent to about 100 percent. The photoreceptor is exposed to electromagnetic radiation. A latent image is formed by the electromagnetic radiation. A visible image is formed by developing the latent image. The visible image is transferred to a print substrate. The N,N,N′N′-tetra(4-methylphenyl)-(1,1′-biphenyl)-4,4′-diamine has been treated by a purification process two or more times. The purification process includes providing a mixture of N,N,N′N′-tetra(4-methylphenyl)-(1,1′-biphenyl)-4,4′-diamine and an absorbent selected from the group consisting of alumina, silica, magnesium sulfate and activated clays. The mixture is refluxed with a solvent at a temperature of from about 80° C. to about 180° C. for a period of time of from about 4 hours to about 48 hours. The solvent is filtered to obtain N,N,N′N′-tetra(4-methylphenyl)-(1,1′-biphenyl)-4,4′-diamine.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a cross-sectional view of an exemplary embodiment of a photoreceptor drum.

FIG. 2 is a cross-sectional view of an exemplary embodiment of a photoreceptor drum.

FIG. 3 is a flow chart for the purification of TM-TBD using a Kaufmann column.

FIG. 4 is an electrical trace plot of discharge voltage of a photoreceptor of an embodiment described herein and a control.

It should be noted that some details of the figures have been simplified and are drawn to facilitate understanding of the embodiments rather than to maintain strict structural accuracy, detail, and scale.

### DESCRIPTION OF THE EMBODIMENTS

In the following description, reference is made to the chemical formulas that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

In an electrostatographic reproducing apparatus for which the photoconductors of the present disclosure can be selected, a light image of an original to be copied is recorded in the form of an electrostatic latent image upon a photosensitive member, and the latent image is subsequently rendered visible by the application of electroscopic thermoplastic resin particles, which are commonly referred to as toner. Specifically, the photoreceptor is charged on its surface by means of an electrical charger to which a voltage has been supplied from a power supply. The photoreceptor is then imagewise exposed to light from an optical system or an image input apparatus, such as a laser and light emitting diode, to form an electrostatic latent image thereon. Generally, the electrostatic latent image is developed by a developer mixture of toner and carrier particles. Development can be accomplished by known processes, such as a magnetic brush, powder cloud, highly agitated zone development, or other known development process.

After the toner particles have been deposited on the photoconductive surface in image configuration, they are transferred to a copy sheet by a transfer means, which can be pressure transfer or electrostatic transfer. In embodiments, the developed image can be transferred to an intermediate transfer member, and subsequently transferred to a copy sheet.

When the transfer of the developed image is completed, a copy sheet advances to the fusing station with fusing and pressure rolls, wherein the developed image is fused to a copy sheet by passing the copy sheet between the fusing member and pressure member, thereby forming a permanent image. Fusing may be accomplished by other fusing members, such as a fusing belt in pressure contact with a pressure roller, fusing roller in contact with a pressure belt, or other like systems.

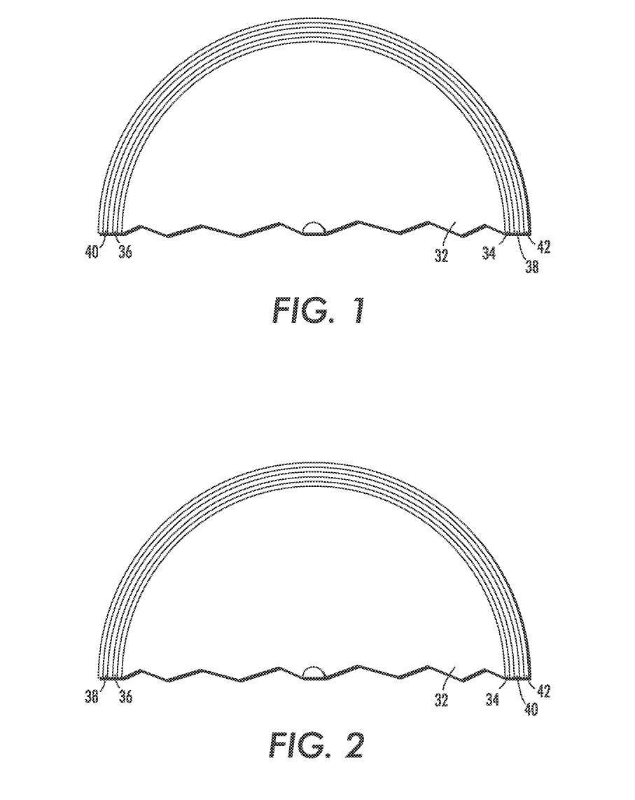

An exemplary embodiment of the photoconductor is shown in FIG. 1. The substrate 32 supports the other layers. An undercoat layer 34 or hole blocking layer is applied, as well as an optional adhesive layer 36. The photogenerating layer 38 is located between the optional adhesive layer 36 and the charge transport layer 40. An overcoat layer 42 is disposed upon the charge transport layer 40.

Another exemplary embodiment of the photoreceptor of the present disclosure is illustrated in FIG. 2. This embodiment is similar to that of FIG. 1, except locations of the photogenerating layer 38 and charge transport layer 40 are reversed. Generally, the photogenerating layer, charge transport layer, and other layers may be applied in any suitable order to produce either positive or negative charging photoreceptor drums. Although depicted as a drum in FIGS. 1 and 2, the photoconductor can be in the form of a belt or web.

USSN 2008/0057426 material discloses aryl amines including TM-TBD that are useful as charge transport materials in charge transport layer 40.

Shown below is the structure of N,N,N′N′-tetra(4-methylphenyl)-(1,1′-biphenyl)-4,4′-diamine:

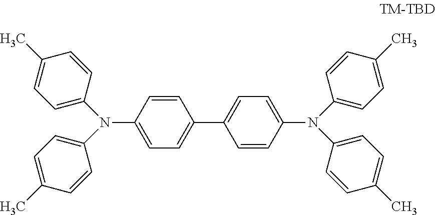

TM-TBD hole transport molecule that can exhibit ultra fast discharge. It has been found that this property is reliably produced when the TM-TBD has undergone at least two purification procedures. A first purification does not reliably produce a fast discharge rate even if the purity of the TM-TBD is at least 99 percent. Conducting at least a second purification procedure on the TM-TBD sample produces a reliable fast discharge charge transport molecule in a manufacturing process that is repeatable and reliable.

Disclosed herein is the discovery that to obtain high discharge rate TM-TBD hole transport molecule at least two purifications are required regardless of measured purity. Due to the decoupling of the measured purity from at least two serial purifications, a reliable and repeatable process for manufacturing a photoconductor with a high discharge rate is provided.

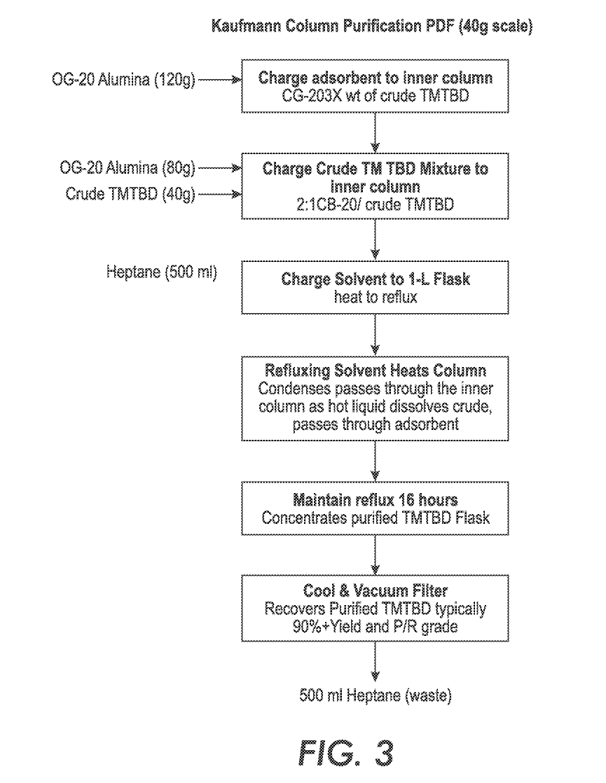

The general process for purification of TM-TBD involves mixing of N,N,N′N′-tetra(4-methylphenyl)-(1,1′-biphenyl)-4,4′-diamine and an absorbent. A flowchart of a more specific process is provided in FIG. 3. The absorbent is selected from the group consisting of alumina, silica, magnesium sulfate and activated clays, such as Filtrol® available from Sigma-Aldrich. The mixture is refluxed with a solvent. The solvent can be heptane, toluene, xylene, ethyl acetate, isoparrafin, cyclohexane or benzene. The refluxing process is conducted at a temperature of from about 80° C. to about 180° C. In embodiments, the temperature is from about 90° C. to about 170° C., or from about 100° C. to about 165° C. The refluxing is conducted for a period of time ranging from about 4 hours to about 48 hours. When the refluxing is complete the solvent is filtered to obtain the purified N,N,N′N′-tetra(4-methylphenyl)-(1,1′-biphenyl)-4,4′-diamine.

Examples of the binder materials suitable for the charge transport layer 40 include polycarbonates, polyarylates, acrylate polymers, vinyl polymers, cellulose polymers, polyesters, polysiloxanes, polyamides, polyurethanes, poly(cyclo olefins), epoxies, and random or alternating copolymers thereof; and more specifically, polycarbonates such as poly(4,4′-isopropylidene-diphenylene) carbonate (also referred to as bisphenol-A-polycarbonate), poly(4,4′-cyclohexylidinediphenylene) carbonate (also referred to as bisphenol-Z-polycarbonate), poly(4,4′-isopropylidene-3,3′-dimethyl-diphenyl) carbonate (also referred to as bisphenol-C-polycarbonate), and the like. In embodiments, electrically inactive binders are comprised of polycarbonate resins with a molecular weight of from about 20,000 to about 100,000, or with a molecular weight M_{w} of from about 50,000 to about 100,000. Generally, the transport layer contains from about 10 percent to about 75 percent by weight of the charge transport material, and more specifically, from about 35 percent to about 50 percent of this material. The charge transport layer 40 is of a thickness of from about 5 microns to about 75 microns, and more specifically, of a thickness of from about 10 microns to about 45 microns. The TM-TBD is present in the charge transport layer in an amount of from about 30 weight percent to about 70 weight percent, or from about 40 weight percent to about 60 weight percent or from about 45 weight percent to about 60 weight percent. When the TM-TBD was purified two or more times, a high discharge rate photoconductor was reliably produced.

The present disclosure relates to embodiments of a photoconductor comprising a supporting substrate, a photogenerating layer, a charge transport layer, and an optional overcoat layer. The charge transport layer is comprised of N,N,N′N′-tetra(4-methylphenyl)-(1,1′-biphenyl)-4,4′-diamine in a binder wherein the N,N,N′N′-tetra(4-methylphenyl)-(1,1′-biphenyl)-4,4′-diamine has been purified two or more times.

### Photoconductor Layer Examples

There can be selected for the photoconductors disclosed herein a number of known layers as shown in FIGS. 1 and 2, such as substrates 32, photogenerating generating layers 38 (also referred to as charge generation layers), charge transport layers (CTL) 40, hole blocking layers 34, adhesive layers 36, protective overcoat layers 42, and the like. Examples, thicknesses and specific components of many of these layers include the following:

### Substrate

The thickness of the photoconductor substrate layer 32 depends on various factors, including economical considerations, desired electrical characteristics, adequate flexibility, and the like, thus this layer may be of substantial thickness, for example over 3,000 microns, such as from about 1,000 microns to about 2,000 microns, from about 500 microns to about 1,000 microns, or from about 300 microns to about 700 microns, (“about” throughout includes all values in between the values recited) or of a minimum thickness. In embodiments, the thickness of this layer is from about 75 microns to about 300 microns, or from about 100 microns to about 150 microns. In embodiments, the photoconductor can be free of a substrate; for example, the layer usually in contact with the substrate can be increased in thickness. For a photoconductor drum, the substrate or supporting medium may be of substantial thickness of, for example, up to many centimeters or of a minimum thickness of less than a millimeter. Similarly, a flexible belt may be of a substantial thickness of, for example, about 250 micrometers, or of a minimum thickness of less than about 50 microns, provided there are no adverse effects on the final electrophotographic device.

The photoconductor substrate 32 may be opaque, substantially opaque, or substantially transparent, and may comprise any suitable material that, for example, permits the photoconductor layers to be supported. Accordingly, the substrate may comprise a number of known layers, and more specifically, the substrate can be comprised of an electrically nonconductive or conductive material such as an inorganic or an organic composition. As electrically nonconducting materials, there may be selected various resins known for this purpose, including polyesters, polycarbonates, polyamides, polyurethanes, and the like, which are flexible as thin webs. An electrically conducting substrate may comprise any suitable metal of, for example, aluminum, nickel, steel, copper, and the like, or a polymeric material filled with an electrically conducting substance, such as carbon, metallic powder, and the like, or an organic electrically conducting material. The electrically insulating or conductive substrate may be in the form of an endless flexible belt, a web, a rigid cylinder, a sheet, and the like.

In embodiments where the substrate layer 32 is to be rendered conductive, the surface thereof may be rendered electrically conductive by an electrically conductive coating. The conductive coating may vary in thickness depending upon the optical transparency, degree of flexibility desired, and economic factors, and in embodiments this layer can be of a thickness of from about 0.05 micron to about 5 microns.

Illustrative examples of substrates are described herein, and more specifically, supporting substrate layers selected for the photoconductors of the present disclosure comprise a layer of insulating material including inorganic or organic polymeric materials, such as MYLAR®, a commercially available polymer, MYLAR® containing titanium, a layer of an organic or inorganic material having a semiconductive surface layer, such as indium tin oxide, or aluminum arranged thereon, or a conductive material inclusive of aluminum, chromium, nickel, brass, or the like. The substrate may be flexible, seamless, or rigid, and may have a number of many different configurations, such as for example, a plate, a cylindrical drum, a scroll, an endless flexible belt, and the like. In embodiments, the substrate is in the form of a seamless flexible belt. In some situations, it may be desirable to coat on the back of the substrate, particularly when the substrate is a flexible organic polymeric material, an anticurl layer, such as for example polycarbonate materials commercially available as MAKROLON®.

### Hole Blocking Layer

The optional hole blocking 34 or undercoat layer for the imaging members of the present disclosure can contain a number of components including known hole blocking components, such as amino silanes, doped metal oxides, a metal oxide like titanium, chromium, zinc, tin, and the like; a mixture of phenolic compounds and a phenolic resin or a mixture of two phenolic resins, and optionally a dopant such as SiO₂. The phenolic compounds usually contain at least two phenol groups, such as bisphenol A (4,4′-isopropylidenediphenol), E (4,4′-ethylidenebisphenol), F (bis(4-hydroxyphenyl)methane), M (4,4′-(1,3-phenylenediisopropylidene)bisphenol), P (4,4′-(1,4-phenylene diisopropylidene)bisphenol), S (4,4′-sulfonyldiphenol), and Z (4,4′-cyclohexylidenebisphenol); hexafluorobisphenol A (4,4′-(hexafluoro isopropylidene)diphenol), resorcinol, hydroxyquinone, catechin, and the like.

The hole blocking layer 34 can be, for example, comprised of from about 20 weight percent to about 80 weight percent, and more specifically, from about 55 weight percent to about 65 weight percent of a suitable component like a metal oxide, such as TiO₂; from about 20 weight percent to about 70 weight percent, and more specifically, from about 25 weight percent to about 50 weight percent of a phenolic resin; from about 2 weight percent to about 20 weight percent and, more specifically, from about 5 weight percent to about 15 weight percent of a phenolic compound containing at least two phenolic groups, such as bisphenol S; and from about 2 weight percent to about 15 weight percent, and more specifically, from about 4 weight percent to about 10 weight percent of a plywood suppression dopant, such as SiO₂. The hole blocking layer coating dispersion can, for example, be prepared as follows. The metal oxide/phenolic resin dispersion is first prepared by ball milling or dynomilling until the median particle size of the metal oxide in the dispersion is less than about 10 nanometers, for example from about 5 nanometers to about 9 nanometers. To the above dispersion are added a phenolic compound and dopant followed by mixing. The hole blocking layer coating dispersion can be applied by dip coating or web coating, and the layer can be thermally cured after coating. The hole blocking layer resulting is, for example, of a thickness of from about 0.01 micron to about 30 microns, and more specifically, from about 0.1 micron to about 8 microns. Examples of phenolic resins include formaldehyde polymers with phenol, p-tert-butylphenol, cresol, such as VARCUM™ 29159 and 29101 (available from OxyChem Company), and DURITE™ 97 (available from Borden Chemical); formaldehyde polymers with ammonia, cresol and phenol, such as VARCUM™ 29112 (available from OxyChem Company); formaldehyde polymers with 4,4′-(1-methylethylidene)bisphenol, such as VARCUM™ 29108 and 29116 (available from OxyChem Company); formaldehyde polymers with cresol and phenol, such as VARCUM™ 29457 (available from OxyChem Company), DURITE™ SD-423A, SD-422A (available from Borden Chemical); or formaldehyde polymers with phenol and p-tert-butylphenol, such as DURITE™ ESD 556C (available from Border Chemical).

The optional hole blocking layer 34 may be applied to the substrate. Any suitable and conventional blocking layer capable of forming an electronic barrier to holes between the adjacent photoconductive layer (or electrophotographic imaging layer) and the underlying conductive surface of substrate may be selected.

### Photogenerating Layer

Generally, the photogenerating layer 38 can contain known photogenerating pigments, such as metal phthalocyanines, metal free phthalocyanines, and more specifically, alkylhydroxyl gallium phthalocyanines, hydroxygallium phthalocyanines, chlorogallium phthalocyanines, perylenes, especially bis(benzimidazo)perylene, titanyl phthalocyanines, and the like, and yet more specifically, vanadyl phthalocyanines, Type V hydroxygallium phthalocyanines, and inorganic components such as selenium, selenium alloys, and trigonal selenium. The photogenerating pigment can be dispersed in a resin binder similar to the resin binders selected for the charge transport layer, or alternatively no resin binder need be present. Generally, the thickness of the photogenerating layer depends on a number of factors, including the thicknesses of the other layers and the amount of photogenerating material contained in the photogenerating layer. Accordingly, this layer can be of a thickness of, for example, from about 0.05 micron to about 10 microns, and more specifically, from about 0.25 micron to about 2 microns when, for example, the photogenerating compositions are present in an amount of from about 30 to about 75 percent by volume.

The photogenerating composition or pigment is present in the resinous binder composition in various amounts, inclusive of 100 percent by weight based on the weight of the photogenerating components that are present. Generally, however, from about 5 percent by volume to about 95 percent by volume of the photogenerating pigment is dispersed in about 95 percent by volume to about 5 percent by volume of the resinous binder, or from about 20 percent by volume to about 30 percent by volume of the photogenerating pigment is dispersed in about 70 percent by volume to about 80 percent by volume of the resinous binder composition. In one embodiment, about 90 percent by volume of the photogenerating pigment is dispersed in about 10 percent by volume of the resinous binder composition, and which resin may be selected from a number of known polymers, such as poly(vinyl butyral), poly(vinyl carbazole), polyesters, polycarbonates, poly(vinyl chloride), polyacrylates and methacrylates, copolymers of vinyl chloride and vinyl acetate, phenolic resins, polyurethanes, poly(vinyl alcohol), polyacrylonitrile, polystyrene, and the like. It is desirable to select a coating solvent that does not substantially disturb or adversely affect the other previously coated layers of the device. Examples of coating solvents for the photogenerating layer are ketones, alcohols, aromatic hydrocarbons, halogenated aliphatic hydrocarbons, ethers, amines, amides, esters, and the like. Specific solvent examples are cyclohexanone, acetone, methyl ethyl ketone, methanol, ethanol, butanol, amyl alcohol, toluene, xylene, chlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, and the like.

The photogenerating layer 38 may comprise amorphous films of selenium and alloys of selenium and arsenic, tellurium, germanium, and the like, hydrogenated amorphous silicon and compounds of silicon, and germanium, carbon, oxygen, nitrogen, and the like fabricated by vacuum evaporation or deposition. The photogenerating layer may also comprise inorganic pigments of crystalline selenium and its alloys; Groups II to VI compounds; and organic pigments such as quinacridones, polycyclic pigments such as dibromo anthanthrone pigments, perylene and perinone diamines, polynuclear aromatic quinones, azo pigments including bis-, tris- and tetrakis-azos, and the like dispersed in a film forming polymeric binder and fabricated by solvent coating techniques.

In embodiments, examples of polymeric binder materials that can be selected as the matrix for the photogenerating layer 38 components are known and include thermoplastic and thermosetting resins, such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, poly(phenylene sulfides), poly(vinyl acetate), polysiloxanes, polyacrylates, polyvinyl acetals, polyamides, polyimides, amino resins, phenylene oxide resins, terephthalic acid resins, phenoxy resins, epoxy resins, phenolic resins, polystyrene, and acrylonitrile copolymers, poly(vinyl chloride), vinyl chloride and vinyl acetate copolymers, acrylate copolymers, alkyd resins, cellulosic film formers, poly(amideimide), styrenebutadiene copolymers, vinylidene chloride-vinyl chloride copolymers, vinyl acetate-vinylidene chloride copolymers, styrene-alkyd resins, poly(vinyl carbazole), and the like. These polymers may be block, random, or alternating copolymers.

Various suitable and conventional known processes may be used to mix and thereafter apply the photogenerating layer coating mixture. The processes may include, for example, spraying, dip coating, roll coating, wire wound rod coating, vacuum sublimation, and the like. For some applications, the photogenerating layer 38 may be fabricated in a dot or line pattern. Removal of the solvent of a solvent-coated layer may be effected by any known conventional techniques such as oven drying, infrared radiation drying, air drying, and the like.

The final dry thickness of the photogenerating layer 38 is as illustrated herein, and can be, for example, from about 0.01 micron to about 30 microns after being dried at, for example, about 40° C. to about 150° C. for about 15 minutes to about 90 minutes. More specifically, a photogenerating layer of a thickness, for example, of from about 0.1 micron to about 30 microns, or from about 0.5 microns to about 2 microns can be applied to or deposited on the substrate, on other surfaces in between the substrate and the charge transport layer, and the like. A charge blocking layer or hole blocking layer 34 may optionally be applied to the electrically conductive surface prior to the application of a photogenerating layer 38. When desired, an adhesive layer 36 may be included between the charge blocking or hole blocking layer 34, or and the photogenerating layer 38. Usually, the photogenerating layer 38 is applied onto the blocking layer 34, and a charge transport layer 40 or plurality of charge transport layers are formed on the photogenerating layer 38. This structure may have the photogenerating layer 38 on top of or below the charge transport layer 40.

### Adhesive Layer

In embodiments, a suitable known adhesive layer 36 can be included in the photoconductor. Typical adhesive layer materials include, for example, polyesters, polyurethanes, and the like. The adhesive layer thickness can vary and in embodiments is, for example, from about 0.05 micron (500 Angstroms) to about 0.3 micron (3,000 Angstroms). The adhesive layer can be deposited on the hole blocking layer by spraying, dip coating, roll coating, wire wound rod coating, gravure coating, Bird applicator coating, and the like. Drying of the deposited coating may be effected by, for example, oven drying, infrared radiation drying, air drying, and the like.

As an optional adhesive layer usually in contact with or situated between the hole blocking layer 34 and the photogenerating layer 38, there can be selected various known substances inclusive of copolyesters, polyamides, poly(vinyl butyral), poly(vinyl alcohol), polyurethane, and polyacrylonitrile. This layer is, for example, of a thickness of from about 0.001 micron to about 1 micron, or from about 0.1 micron to about 0.5 micron. Optionally, this layer may contain effective suitable amounts, for example from about 1 weight percent to about 10 weight percent, of conductive and nonconductive particles, such as zinc oxide, titanium dioxide, silicon nitride, carbon black, and the like, to provide, for example, in embodiments of the present disclosure further desirable electrical and optical properties.

### Charge Transport Layer

Additional charge transport materials in the charge transport layer 40 described previously may include, for example, hole transporting materials selected from compounds having in the main chain or the side chain a polycyclic aromatic ring such as anthracene, pyrene, phenanthrene, coronene, and the like, or a nitrogen-containing hetero ring such as indole, carbazole, oxazole, isoxazole, thiazole, imidazole, pyrazole, oxadiazole, pyrazoline, thiadiazole, triazole, and hydrazone compounds. Typical hole transport materials include electron donor materials, such as carbazole; N-ethyl carbazole; N-isopropyl carbazole; N-phenyl carbazole; tetraphenylpyrene; 1-methylpyrene; perylene; chrysene; anthracene; tetraphene; 2-phenyl naphthalene; azopyrene; 1-ethyl pyrene; acetyl pyrene; 2,3-benzochrysene; 2,4-benzopyrene; 1,4-bromopyrene; poly(N-vinylcarbazole); poly(vinylpyrene); poly(vinyltetraphene); poly(vinyltetracene) and poly(vinylperylene). Suitable electron transport materials include electron acceptors such as 2,4,7-trinitro-9-fluorenone; 2,4,5,7-tetranitro-fluorenone; dinitroanthracene; dinitroacridene; tetracyanopyrene; dinitroanthraquinone; and butylcarbonylfluorenemalononitrile, see U.S. Pat. No. 4,921,769 the disclosure of which is incorporated herein by reference in its entirety. Other hole transporting materials include arylamines described in U.S. Pat. No. 4,265,990 the disclosure of which is incorporated herein by reference in its entirety, such as N,N′-diphenyl-N,N′-bis(alkylphenyl)-(1,1′-biphenyl)-4,4′-diamine wherein alkyl is selected from the group consisting of methyl, ethyl, propyl, butyl, hexyl, and the like. Other known charge transport layer molecules may be selected, reference for example U.S. Pat. Nos. 4,921,773 and 4,464,450 the disclosures of which are incorporated herein by reference in their entireties.

Any suitable technique may be utilized to apply the charge transport layer and the charge generating layer to the substrate. Typical coating techniques include dip coating, roll coating, spray coating, rotary atomizers, and the like. The coating techniques may use a wide concentration of solids. The solids content is between about 2 percent by weight and 30 percent by weight based on the total weight of the dispersion. The expression “solids” refers, for example, to the charge transport particles and binder components of the charge transport coating dispersion. These solids concentrations are useful in dip coating, roll, spray coating, and the like. Generally, a more concentrated coating dispersion may be used for roll coating. Drying of the deposited coating may be effected by any suitable conventional technique such as oven drying, infra-red radiation drying, air drying and the like. Generally, the thickness of the transport layer is between about 5 micrometers to about 100 micrometers, but thicknesses outside these ranges can also be used. In general, the ratio of the thickness of the charge transport layer to the charge generating layer is maintained, for example, from about 2:1 to 200:1 and in some instances as great as about 400:1.

The charge transport layer 40 or layers, and more specifically, a first charge transport in contact with the photogenerating layer, and thereover, a top or second charge transport overcoating layer may comprise charge transporting small molecules dissolved or molecularly dispersed in a film forming electrically inert polymer such as a polycarbonate. In embodiments, “dissolved” refers, for example, to forming a solution in which the small molecule is dissolved in the polymer to form a homogeneous phase; and “molecularly dispersed in embodiments” refers, for example, to charge transporting molecules dispersed in the polymer, the small molecules being dispersed in the polymer on a molecular scale. Various charge transporting or electrically active small molecules may be selected for the charge transport layer or layers. In embodiments, charge transport refers, for example, to charge transporting molecules as a monomer that allows the free charge generated in the photogenerating layer to be transported across the transport layer.

Examples of components or materials optionally incorporated into the charge transport layers 40 or at least one charge transport layer to, for example, enable excellent lateral charge migration (LCM) resistance include hindered phenolic antioxidants, such as tetrakis methylene(3,5-di-tert-butyl-4-hydroxy hydrocinnamate) methane (IRGANOX™ 1010, available from Ciba Specialty Chemical), butylated hydroxytoluene (BHT), and other hindered phenolic antioxidants including SUMILIZER™ BHT-R, MDP-S, BBM-S, WX-R, NW, BP-76, BP-101, GA-80, GM and GS (available from Sumitomo Chemical Co., Ltd.), IRGANOX™ 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SNKYO CO., Ltd.), TINUVIN™ 144 and 622LD (available from Ciba Specialties Chemicals), MARK™ LA57, LA67, LA62, LA68 and LA63 (available from Asahi Denka Co., Ltd.), and SUMILIZER™ TPS (available from Sumitomo Chemical Co., Ltd.); thioether antioxidants such as SUMILIZER™ TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layers is from about 0 to about 20, from about 1 to about 10, or from about 3 to about 8 weight percent.

A number of processes may be used to mix, and thereafter, apply the charge transport layer 40 or layers coating mixture to the photogenerating layer. Typical application techniques include spraying, dip coating, roll coating, wire wound rod coating, and the like. Drying of the charge transport deposited coating may be effected by any suitable conventional technique such as oven drying, infrared radiation drying, air drying, and the like.

The thickness of each of the charge transport layer 40 in embodiments is from about 5 microns to about 75 microns, but thicknesses outside this range may in embodiments also be selected. The charge transport layer 40 should be an insulator to the extent that an electrostatic charge placed on the hole transport layer is not conducted in the absence of illumination at a rate sufficient to prevent formation and retention of an electrostatic latent image thereon. In general, the ratio of the thickness of the charge transport layer 40 to the photogenerating layer 38 can be from about 2:1 to 200:1, and in some instances 400:1. The charge transport layer 40 is substantially nonabsorbing to visible light or radiation in the region of intended use, but is electrically “active” in that it allows the injection of photogenerated holes from the photogenerating layer 38, and allows these holes to be transported through itself to selectively discharge a surface charge on the surface of the active layer. Typical application techniques include spraying, dip coating, roll coating, wire wound rod coating, and the like. Drying of the deposited coating may be effected by any suitable conventional technique, such as oven drying, infrared radiation drying, air drying, and the like.

### Overcoat Layer

Embodiments in accordance with the present disclosure can, optionally, further include an overcoat layer or layers 42, which, if employed, are positioned over the charge generation layer 38 or over the charge transport layer 40.

In embodiments, the overcoat layer 42 may have a thickness ranging from about 0.1 micrometer to about 25 micrometers or from about 1 micrometer to about 10 micrometers, or in a specific embodiment, about 3 micrometers to about 10 micrometers. These overcoat layers typically comprise a charge transport component and an optional organic polymer or inorganic polymer. These overcoat layers may include thermoplastic organic polymers or cross-linked polymers such as thermosetting resins, UV or e-beam cured resins, and the likes. In embodiments the overcoat layer can include a polyethylene-block-polyethylene glycol copolymer and a melamine resin.

The overcoat layers may further include a particulate additive such as metal oxides including aluminum oxide and silica, or low surface energy polytetrafluoroethylene (PTFE), and combinations thereof. Any known or new overcoat materials may be included for the present embodiments. In embodiments, the overcoat layer may include a charge transport component or a cross-linked charge transport component. In particular embodiments, for example, the overcoat layer comprises a charge transport component comprised of a tertiary arylamine containing substituent capable of self cross-linking or reacting with the polymer resin to form a cured composition.

In embodiments, the overcoat 42 may comprise structured organic films (SOFs) that are electrically insulating or slightly semi-conductive. Such overcoat includes a structured organic film forming reaction mixture containing a plurality of molecular building blocks that optionally contain charge transport segments as described in U.S. Pat. No. 8,372,566 incorporated by reference in its entirety.

Additives may be present in the overcoating layer in the range of about 0.5 to about 40 weight percent of the overcoating layer. In embodiments, additives include organic and inorganic particles which can further improve the wear resistance and/or provide charge relaxation property. In embodiments, organic particles include Teflon powder, carbon black, and graphite particles. In embodiments, inorganic particles include insulating and semiconducting metal oxide particles such as silica, zinc oxide, tin oxide and the like. Another semiconducting additive is the oxidized oligomer salts as described in U.S. Pat. No. 5,853,906 the disclosure of which is incorporated herein by reference in its entirety.

While embodiments have been illustrated with respect to one or more implementations, alterations and/or modifications can be made to the illustrated examples without departing from the spirit and scope of the appended claims. In addition, while a particular feature herein may have been disclosed with respect to only one of several implementations, such feature may be combined with one or more other features of the other implementations as may be desired and advantageous for any given or particular function.

### EXAMPLES

### Step 1

### TM-TBD Purification by Kaufman Column

The product TM-TBD was purified in a Kaufmann column. The flow chart for the process is outlined in FIG. 3. The Kaufmann column was charged with alumina (CG-20) in the inner chamber of the Kaufmann column. A mixture of TM-TBD and alumina was charged to the inner chamber of the Kaufman column at about a 2 to 1 weight ratio of alumina to TM-TBD. Heptane was charged to the outer vessel and refluxed through the inner vessel of the Kaufman column for about 16 hours. The heptane was collected and cooled and the TM-TBD crystallized. The crystals were collected by filtration and dried in a vacuum oven. The TM-TBD had a measured purity of from about 94 percent to about 100 percent.

### Step 2

### TM-TBD Characterization of Purity Via HPLC

Using a High Pressure Liquid Chromatograph (HPLC) the measured purity of TM-TBD was determined. Sample were analyzed with a UV Water 2996 Photodiode Array Detector.

### Device Preparation

An imaging member incorporating N,N,N′N′-tetra(4-methylphenyl)-(1,1′-biphenyl)-4,4′-diamine (TM-TBD) purified by Step 1 and characterized by Step 2 was prepared in accordance with the following procedure. A metallized mylar substrate was provided and a HOGaPc/poly(bisphenol-Z carbonate) photogenerating layer was machine coated over the substrate. A charge transport layer was prepared by introducing into an amber glass bottle 50 weight percent of TM-TBD, and 50 weight percent of Makrolon polymer. The resulting mixture was then dissolved in methylene chloride to form a solution containing 15 percent by weight solids. This solution was applied on the photogenerating layer to form a layer coating that upon drying (120° C. for 1 minute) had a thickness of 30 microns.

A control imaging member was prepared by repeating the above procedure except that the charge transport layer was prepared by introducing into an amber glass bottle 50 weight percent of N,N′-diphenyl-N,N-bis(3-methylphenyl)-1,1′-biphenyl-4,4′-diamine (m-TBD) that had not been subjected to the purification steps (Step 1 and Step 2), and 50 weight percent of Makrolon polymer.

### Device Evaluation

The xerographic electrical properties of the above prepared photoconductors were determined by a xerographic scanner. The surface of the device was charged with a corona discharge source until the surface potential, as measured by a capacitively coupled probe attached to an electrometer, attained an initial value V₀ of about −800 volts. After resting for a 0.5 second in the dark, the charged members attained a surface potential of V_{ddp}, (dark development potential). The photoconductive imaging members were then exposed to light from a filtered Xenon lamp with a 150 watt bulb, thereby inducing a photodischarge which resulted in a reduction of surface potential to a V_{low} value. The wavelength of the incident light was 780 nanometers, and the exposure energy of the incident light was 6 ergs/cm². The results obtained for the photoconductive members fabricated in accordance with the above examples are summarized in Table 1.

TABLE 1
Purity and electrical data for m-TBD and TM-TBD samples.

| | 1^{st} Purification | | | | 2^{nd} Purification | | | |
|---|---|---|---|---|---|---|---|---|
| | Purity | | | | Purity | | | |
| | (%) | V_{low} | Vᵣ | | (%) | V_{low} | Vᵣ | |
| Sample | (HPLC) | Volts | Volts | Comments | (HPLC) | Volts | Volts | Comments |
| Comp. Ex. 1 | 99.64 | 28 | 12 | Typical | 100 | 30 | 13 | No Improvement |
| (m-TBD) | | | | Performance | | | | |
| Example 1 | 99.82 | 24 | 11 | No Benefit over | 100 | 7 | 4 | Improvement over |
| (TM-TBD) | | | | Comp Ex. 1 | | | | Comp Ex. 1 |
| Example 2 | 96.62 | 35 | 19 | No Benefit over | 99.69 | 7 | 2 | Improvement over |
| (TM-TBD) | | | | Comp Ex. 1 | | | | Comp Ex. 1 |
| Example 3 | 94.82 | 44 | 24 | No Benefit over | 99.84 | 12 | 3 | Improvement over |
| (TM-TBD) | | | | Comp Ex. 1 | | | | Comp Ex. 1 |
| Example 5 | 100 | 28 | 20 | No Benefit over | 100 | 8 | 5 | Improvement over |
| (TM-TBD) | | | | Comp Ex. 1 | | | | Comp Ex. 1 |

Comparative Example 1 after a first purification had a measured purity of 99.64 percent and demonstrated a relatively slow discharge rate with a V_{low} of 28 volts after photoexposure. When purified a second time as per Step 1, this sample showed no improvement in electrical performance demonstrating a similarly slow discharge rate with a V_{low} of 30 volts after photoexposure.

Examples 1, 2, 3 and 5 after a first purification had a measured purity ranging from 94 percent to 100 percent, yet all Examples 1, 2, 3 and 5 demonstrated a similarly slow discharge rate to that of Comparative Example 1. Only when Examples 1, 2, 3 and 5 were purified a second time did they demonstrate significantly faster discharge rates when compared to Comparative Example 1.

As can be seen from the results in Table 1, there is no direct correlation between measured purity and discharge rate performance. A 100 percent pure sample (Example 5) can still produce poor discharge rate (as expressed as V_{low}) relative to a sample with exceptional discharge rate. A sample with 99 or greater purity can both have poor performance (Example 1) and excellent performance (Examples 2 and 3). Example 2 has lower purity than Example 1 yet has significantly better performance.

In order to produce the property of high discharge rate (low V_{low}) there must be 2 or more purifications regardless of measured purity.

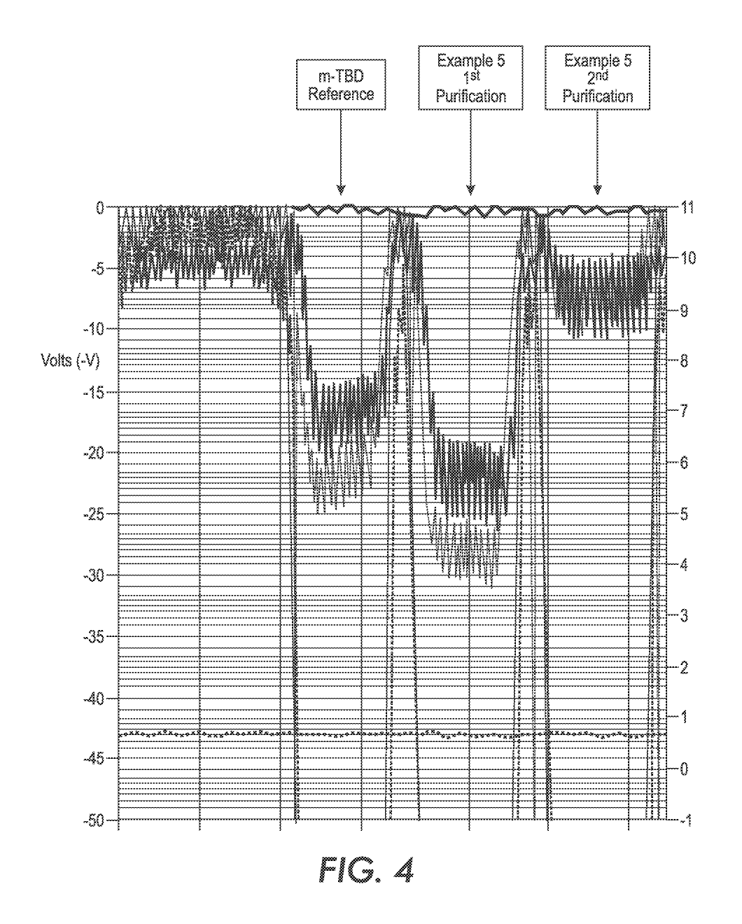

FIG. 4 is an electrical trace plot showing V_{low} (green line) for Example 5 (TM-TBD) versus a reference m-TBD sample. Example 5, after a 1^{st} purification has 100 percent purity, yet demonstrates worse discharge performance than a reference m-TBD sample. Only when Example 5 was purified a second time did the high discharge rate performance occur, which was significantly better than a conventional m-TBD. The results show an unexpected improvement in performance by performing a second purification. The performance is not related to the measured purity of the sample.

It will be appreciated that variants of the above-disclosed and other features and functions or alternatives thereof, may be combined into other different systems or applications. Various presently unforeseen or unanticipated alternatives, modifications, variations, or improvements therein may be subsequently made by those skilled in the art which are also encompassed by the following claims.

What is claimed is:

1. A photoreceptor comprising:
a substrate;
a charge generating layer;
a charge transport layer comprising N,N,N′N′-tetra(4-methylphenyl)-(1,1′-biphenyl)-4,4′-diamine having a purity of from about 95 percent to about 100 percent; and
a protective overcoat layer, wherein the N,N,N′N′-tetra(4-methylphenyl)-(1,1′-biphenyl)-4,4′-diamine has been treated by a purification process two or more times.

2. The photoreceptor of claim 1, wherein the purification process comprises:
providing a mixture of N,N,N′N′-tetra(4-methylphenyl)-(1,1′-biphenyl)-4,4′-diamine and an absorbent selected from the group consisting of alumina, silica, magnesium sulfate and activated clays;
refluxing a solvent through the mixture at a temperature of from about 80° C. to about 180° C. for a period of time of from about 4 hours to about 48 hours;
filtering the solvent to obtain N,N,N′N′-tetra(4-methylphenyl)-(1,1′-biphenyl)-4,4′-diamine.

3. The photoreceptor of claim 2, wherein the solvent is selected from the group consisting of: heptane, toluene, xylene, ethyl acetate, isoparrafin, cyclohexane and benzene.

4. The photoreceptor of claim 1, wherein the charge transport layer further comprises a polymer binder.

5. The photoreceptor of claim 1, wherein the charge transport layer is between from about 1 to about 100 microns thick.

6. The photoreceptor of claim 1, wherein the N,N,N′N′-tetra(4-methylphenyl)-(1,1′-biphenyl)-4,4′-diamine is present in an amount of from about 1% to about 75% by weight of the charge transport layer.

7. The photoreceptor of claim 2, wherein a Kaufmann column is used to conduct the refluxing.

8. A process for forming a photoreceptor comprising: providing a photoreceptor substrate; applying a charge generating layer; applying a charge transport layer comprising N,N,N′N′-tetra(4-methylphenyl)-(1,1′-biphenyl)-4,4′-diamine having a purity of from about 95 percent to about 100 percent; and applying a protective overcoat layer over the substrate wherein the N,N,N′N′-tetra(4-methylphenyl)-(1,1′-biphenyl)-4,4′-diamine has been treated by a purification process two or more times, wherein the purification process comprises:
providing a mixture of N,N,N′N′-tetra(4-methylphenyl)-(1,1′-biphenyl)-4,4′-diamine and an absorbent selected from the group consisting of alumina, silica, magnesium sulfate and activated clays;
refluxing a solvent through the mixture at a temperature of from about 80° C. to about 180° C. for a period of time of from about 4 hours to about 48 hours;
filtering the solvent to obtain N,N,N′N′-tetra(4-methylphenyl)-(1,1′-biphenyl)-4,4′-diamine.

9. The process of claim 8, wherein the solvent is selected from the group consisting of: heptane, toluene, xylene, ethyl acetate, isoparrafin, cyclohexane and benzene.

10. The process of claim 8, wherein the applying comprises: applying a charge generating layer to said substrate; applying a charge transport layer solution comprising at least N,N,N′N′-tetra(4-methylphenyl)-(11,1′-biphenyl)-4,4′-diamine and a film-forming polymer to said charge generating layer; and curing said charge transport layer solution to form said charge transport layer.

11. The process of claim 8, wherein the charge transport layer is between from about 1 to about 100 microns thick.

12. The process of claim 8, wherein the N,N,N′N′-tetra(4-methylphenyl)-(1,1′-biphenyl)-4,4′-diamine is present in an amount of from about 1% to about 75% by weight of the charge transport layer.

13. The process of claim 8, wherein a Kaufmann column is used to conduct the refluxing.

14. A method of forming an image, comprising: applying a charge to a photoreceptor comprising at least a charge transport layer comprising N,N,N′N′-tetra(4-methylphenyl)-(1,1′-biphenyl)-4,4′-diamine having a purity of from about 95 percent to about 100 percent, exposing the photoreceptor to electromagnetic radiation; developing a latent image formed by exposing the photoreceptor to the electromagnetic radiation to form a visible image; and transferring the visible image to a print substrate; wherein the N,N,N′N′-tetra(4-methylphenyl)-(1,1′-biphenyl)-4,4′-diamine has been treated by a purification process two or more times, and wherein the purification process comprises:
providing a mixture of N,N,N′N′-tetra(4-methylphenyl)-(1,1′-biphenyl)-4,4′-diamine and an absorbent selected from the group consisting of alumina, silica, magnesium sulfate and activated clays;
refluxing a solvent through the mixture at a temperature of from about 80° C. to about 180° C. for a period of time of from about 4 hours to about 48 hours;
filtering the solvent to obtain N,N,N′N′-tetra(4-methylphenyl)-(1,1′-biphenyl)-4,4′-diamine.

15. The method of forming an image of claim 14, wherein the applying comprises: applying a charge generating layer to said substrate; applying a charge transport layer solution comprising at least N,N,N′N′-tetra(4-methylphenyl)-(11,1′-biphenyl)-4,4′-diamine and a film-forming polymer to said charge generating layer; and curing said charge transport layer solution to form said charge transport layer.

16. The method of forming an image of claim 14, wherein the solvent is selected from the group consisting of: heptane, toluene, xylene, ethyl acetate, isoparrafin, cyclohexane and benzene.

17. The method of forming an image of claim 14, wherein the charge transport layer is between from about 1 to about 100 microns thick.

18. The method of forming an image of claim 14, wherein the N,N,N′N′-tetra(4-methylphenyl)-(1,1′-biphenyl)-4,4′-diamine is present in an amount of from about 1% to about 75% by weight of the charge transport layer.

19. The method of forming an image of claim 14, wherein a Kaufmann column is used to conduct the refluxing.

20. The method of forming an image of claim 14, wherein the N,N,N′N′-tetra(4-methylphenyl)-(1,1′-biphenyl)-4,4′-diamine has of greater than 99 percent.
